(19) United States
(12) Patent Application Publication
(10) Pub. No.: US 2011/0246289 A1
(43) Pub. Date: Oct. 6, 2011

(54) CLICK MARKETPLACE SYSTEM AND METHOD WITH ENHANCED CLICK TRAFFIC AUCTIONS

(75) Inventors: Brian Bowman, Livermore, CA (US); Brian Kanaga, San Ramon, CA (US)

(73) Assignee: Reply! Inc., San Ramon, CA (US)

(21) Appl. No.: 12/211,732

(22) Filed: Sep. 16, 2008

(51) Int. Cl. G06Q 40/00

(52) U.S. Cl. 705/14.48; 705/37

(57) ABSTRACT

A system for storing and redirecting an Internet user with an enhanced click traffic (ECT) unit between websites of interested parties which employs a distributed network of Click Generators to enhance click traffic and an intermediary website for registering interested partners and conducting an auction of the ECT, having the result of redirecting the Internet user to the most relevant online destination.

### FIELD

The system and method relate to a click marketplace system and method that may be used for various different types of Internet user traffic originating from various sources.

### BACKGROUND

One of the many uses of the Internet is to connect customers who are contemplating a transaction or seeking information with one or more service providers who want to compete for the customer's business. A user may begin their search on a web portal, a search engine, mobile portal, direct entry of web address, web browser component or other method to access data online.

A service provider or Click Generator may acquire traffic to their website through online advertising on IP television, web portals, advertising on search engines, mobile advertising, natural search, video advertising, or offline advertising through newspaper and magazine advertisements. In many cases, Click Generators are seeking geo-targeted Click Traffic (click traffic from users in one or more particular geographic locations or regions) through these various sources. In many cases, Click Generators are also seeking to understand the intent of Click Traffic (whether or not the person who performed the click is actually interested in the product/services of the particular click generator) to their website.

Today it is difficult to efficiently capture geographic information and intent of traffic originating from various online sources including search traffic, text and media advertising, as well as offline sources such as televisions, newspaper and magazine advertisements. In many cases, the website owner or Click Generator has already paid for the traffic without knowing the geography and intent of the consumer. Only after the traffic has entered the Click Generators' website are they able to present an interface which allows users to provide geographic and intent information. As a result, the Click Generator experiences a significant amount of wasted acquisition costs from click traffic that do not result in a transaction or other desired outcome. An Enhanced Click Traffic (ECT) unit consists of a user action as defined by filling out a form or clicking on a link, graphic, button, video or other website component accessed through a plurality of web enabled devices to provide geographic information and intent. The captured information allows a service provider to uniquely identify the customer's intent in an effort to acquire the customer's business or provide other relevant information.

Today it is very difficult for a Click Generator to monetize Enhanced Click Traffic after a transaction is complete. Click Generators have highly valued Click Traffic that another buyer may be willing to purchase, but a secondary market does not exist for Enhanced Click Traffic that can monetize post-transaction traffic.

Today, it is difficult to efficiently capture, price and distribute Enhanced Click Traffic as there is a great amount of variability amongst Click Buyers in the value they place on a Enhanced Click Traffic based on local market factors, characteristics of the customer, time of month, and their current ability to service the business. Furthermore, it is very difficult to cost-effectively capture geo-targeted Enhanced Click Traffic. The impact of this disparity between price and value to the buyer results in excess Enhanced Click Traffic that is unmonitized or Click Traffic that is underpriced and sell at less than the optimal price. Click Generators are faced with a situation where they generate little or no revenue from excess Click Traffic that they cannot service.

Thus, it is desirable to provide a click marketplace system and method that overcomes these problems of conventional systems and it is to this end that the system and method are directed.

### BRIEF DESCRIPTION OF THE DRAWINGS

FIGS. 1A and 1B illustrate an example of a Web-based implementation of a click marketplace system;

FIG. 2 illustrates an example of a Click Buyer campaign creation workflow implemented in the click marketplace system shown in FIGS. 1A and 1B;

FIG. 3 illustrates an example of a Click Seller campaign creation workflow implemented in the click marketplace system shown in FIGS. 1A and 1B;

FIG. 4 illustrates an example of a click upload workflow implemented in the click marketplace system shown in FIGS. 1A and 1B;

FIG. 5 illustrates an example of a click auction workflow implemented in the click marketplace system shown in FIGS. 1A and 1B;

FIG. 6 illustrates an example of an auction workflow implemented in the click marketplace system shown in FIGS. 1A and 1B;

FIG. 7 illustrates an example of auction logic in the click marketplace system shown in FIGS. 1A and 1B;

FIG. 8 illustrates an example of an auctioneer process system function flow implemented in the click marketplace system shown in FIGS. 1A and 1B;

FIG. 9 illustrates an example of a click rating workflow implemented in the click marketplace system shown in FIGS. 1A and 1B;

FIG. 10 illustrates an example of a buyer information workflow implemented in the click marketplace system shown in FIGS. 1A and 1B;

FIG. 11 illustrates an example of a seller information workflow implemented in the click marketplace system shown in FIGS. 1A and 1B;

FIG. 12 illustrates an example of a buying campaign management workflow implemented in the click marketplace system shown in FIGS. 1A and 1B;

FIG. 13 illustrates an example of a selling campaign management workflow implemented in the click marketplace system shown in FIGS. 1A and 1B; and

FIG. 14 illustrates an example of a distributed workflow implemented in the click marketplace system shown in FIGS. 1A and 1B.

### DETAILED DESCRIPTION OF ONE OR MORE EMBODIMENTS

The system and method are particularly applicable to a Web-based click marketplace system and method and it is in this context that the system and method will be described. It will be appreciated, however, that the system and method has greater utility since it may be implemented in different manners, may be based on different architectures and is not limited to the particular types of Enhanced Click Traffic described below. In particular, the click marketplace system and method may be used to buy and sell various types of Enhanced Click Traffic including Enhanced Click Traffic for services, for retail good, or for relevant information.

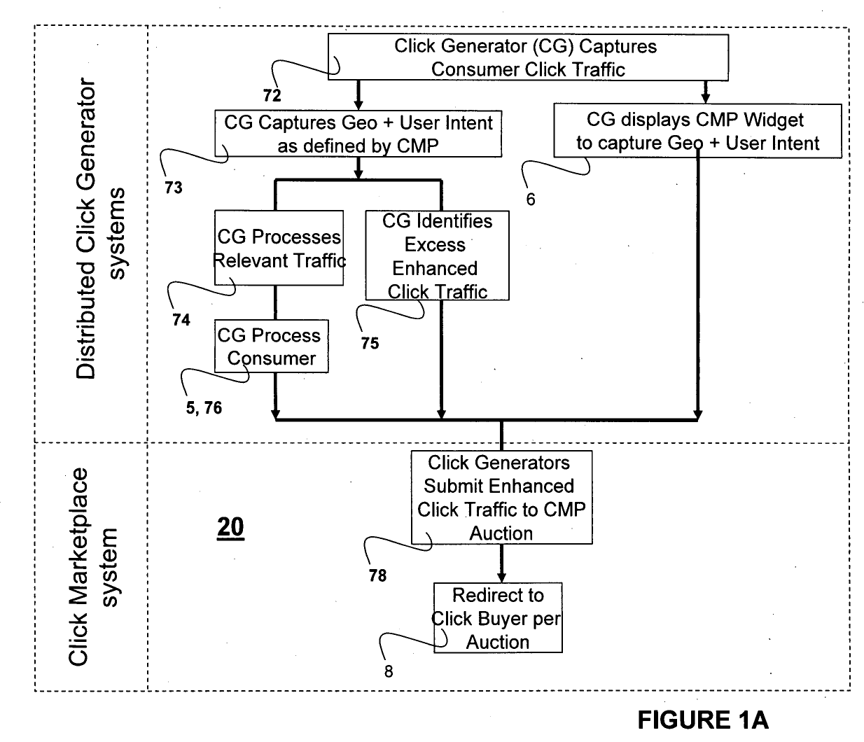

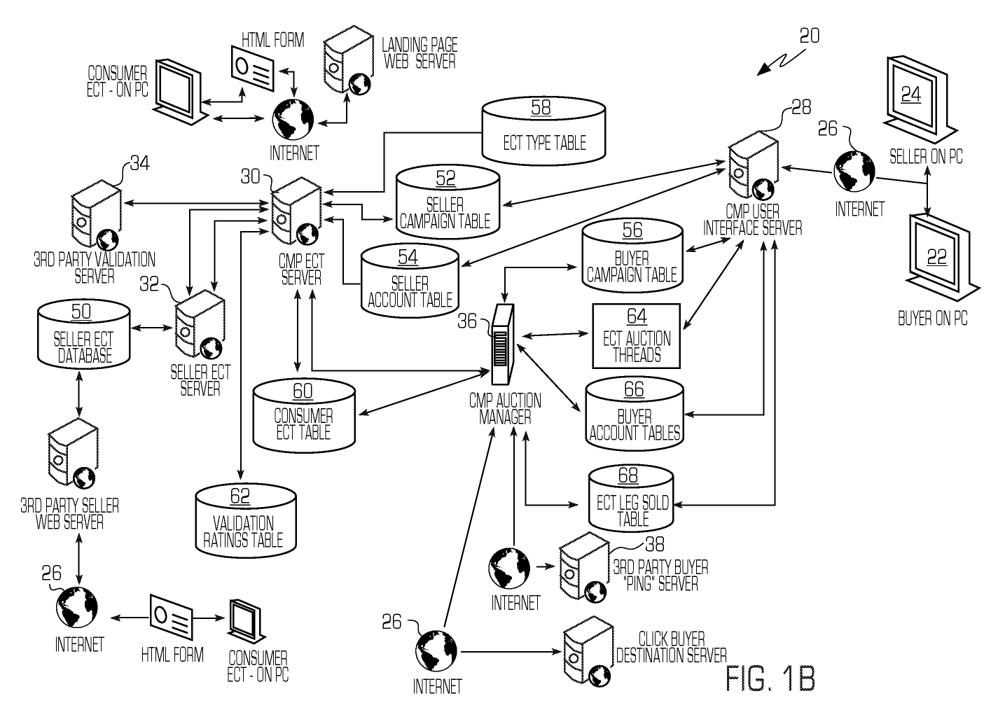

FIG. 1 illustrates an example of a Web-based implementation of a Click Marketplace (CMP). The Click Generator 72 captures consumer click traffic through several known methods available online. Once the Click Traffic enters the Click Generator's system, the Click Generator can then capture 73 user intent and geo or location information from the user by various methods and system as described below in more detail. At this point the traffic is enhanced with intent and geo modifiers and thus becomes an Enhanced Click Traffic unit wherein the Enhanced Click Traffic unit is click traffic for a particular consumer that has user intent and geo or location information. The Click Generator can either process the relevant traffic 74 or identify Enhanced Click Traffic 75 to be submitted to CMP. The processed traffic 5 includes all traffic that the Click Generator considers relevant to their core business needs. Once processed, the Click Generator can also submit that Enhanced Click Traffic 76 to CMP.

A Click Generator may also use a CMP Widget 6 in order to capture user intent and geo or location information. The widget is a banner or other media type that allows a click generator to advertise a product, service or business like Home Improvement to consumers. A consumer selects plumbing in Dallas TX using pull down menus (or other methods) and then is directed to through the CMP to the highest bidder for the service, product or business.

When CMP receives that Enhanced Click Traffic, an auction process 78 with identify the winner and the Enhanced Click Traffic will be redirected 8 to the winner's website or other destination.

An Enhanced Click Traffic unit represents user intent through keywords or other data fields and provides an Click Buyers an opportunity to sell a good or service, or provide relevant information to a prospective customer. An example of an Enhanced Click Traffic would be a web user who is looking for a Ford Mustang in the San Mateo, Calif. area. The web user would provide intent and location information through one of several methods available online, including submitting a form on a website.

A Click Generator unit is an online content publisher or online advertiser that acquires Click Traffic to their respective websites. The traffic may be acquired through search engine queries, paid advertisements, or any other method. The Click Generator may acquire the traffic in order to sell a good or service online, or to provide relevant information to a user. One example of a click generator may be a Ford dealership in the San Francisco, Calif. area that is buying advertisements to drive traffic to their website. Users find the Click Generator's website through search engine or other advertising channel and are directed to the website. For example, a user may search for “Ford Mustang” on a search engine and be directed through links to the Click Generator's website.

A Click Seller unit represents a Click Generator that has registered with the Click Marketplace system to provide clicks into the CMP system. The Click Seller registers their website or websites that provide Enhanced Click Traffic through Seller Campaigns in the CMP system. Each Seller Campaign is associated with a multi-level keyword mapping system that describes the type of Enhanced Click Traffic that the Click Generator will submit into the CMP system. For example, the Click Seller may create a Seller Campaign that maps to the Automotive category. Furthermore, that Automotive category may include a modifier such as Ford or Mustang to better define the Enhanced Click Traffic. The Click Seller may also indicate that they provide Zipcode level location data.

A Click Buyer unit represents a buyer of Enhanced Click Traffic from the CMP system. The Click Buyer registers their website or websites that purchase Enhanced Click Traffic through Buyer Campaigns in the CMP system. Each Buyer Campaign is associated with a multi-level keyword mapping system that describes the type of Enhanced Click Traffic that the Click Buyer will purchase from the CMP system. The Click Buyer may also indicate the geographic scope of their purchase. For example, a Ford Dealership in the San Mateo, Calif. area may register as a Click Buyer and may create a Buyer Campaign for keywords such as Ford and/or Mustang in the Northern California area. The Click Buyer may also indicate one or more price points at which they wish to purchase the Enhanced Click Traffic. Upon winning an auction in the CMP system, the Enhanced Click Traffic will be directed to the Click Buyer's website of choice.

The Click Marketplace system enables Click Sellers to submit Enhanced Click Traffic into the system and sell this traffic to Click Buyers. Using the abovementioned examples, a user who is searching for a Ford Mustang in the San Mateo, Calif. area may use a search engine to search for a website with relevant information. Upon completing this search, the user may click on a hyperlink that directs the user to a Click Generator who has a relevant website about their Ford dealership located in Dallas, Tex. The user then provides contact, intent, and location information through a web form on the Click Generator's website. The Click Generator uses this information to generate an Enhanced Click Traffic unit as defined by the CMP system and maps relevant fields to categories as defined by the CMP system. The Click Generator may then determine that the user is not located in their serviceable area and submits this Enhanced Click Traffic to the CMP system as a Click Seller utilizing a Seller Campaign. A Click Buyer who has a dealership in the San Mateo, Calif. area may bid for this Enhanced Click Traffic with a predefined Buyer Campaign. Upon winning the auction, the Enhanced Click Traffic is redirected by the CMP system to the Click Buyer's website as defined in the Buyer Campaign.

The Click Marketplace system enables Click Sellers to submit Enhanced Click Traffic into the CMP system for any number of categories, including service businesses such as Real Estate. For example, an internet user may use a search engine query or click on an advertisement for a Real Estate expert, or Click Generator, in the Phoenix, Ariz. area. Upon receiving the Click Traffic onto their website, the Click Generator may provide a form to the user to capture intent and location information, thereby creating an Enhanced Click Traffic unit. Using this data, the Click Generator may determine that the user is requesting service that they do not offer, and is unable to provide value to the user. The Click Generator may submit this Enhanced Click Traffic into the CMP system as a Click Seller, where another Click Buyer in the Phoenix, Ariz. area can purchase the Enhanced Click Traffic and direct traffic to the Click Buyer's website to provide relevant information.

The Click Marketplace system enables Click Sellers to submit Enhanced Click Traffic into the CMP system for any number of categories, including service businesses such as Plumbing Repair. For example, an internet user may use a search engine query or click on an advertisement for a Plumber, or Click Generator, in the Detroit, Mich. area. Upon receiving the Click Traffic onto their website, the Click Generator may provide a form to the user to capture intent and location information, thereby creating an Enhanced Click Traffic unit. Using this data, the Click Generator may determine that the user falls outside of their serviceable area, and is unable to provide value to the user. The Click Generator may submit this Enhanced Click Traffic into the CMP system as a Click Seller, where another Click Buyer in the Detroit, Mich. area can purchase the Enhanced Click Traffic and direct traffic to the Click Buyer's website to provide relevant information.

The Click Marketplace system enables Click Sellers to submit Enhanced Click Traffic into the CMP system for any number of categories, including retail goods such as Plasma Televisions. For example, an internet user may use a search engine query or click on an advertisement for a Plasma TV reseller, or Click Generator, in the Long Beach, Calif. area. Upon receiving the Click Traffic onto their website, the Click Generator may provide a form to the user to capture intent and location information, thereby creating an Enhanced Click Traffic unit. Using this data, the Click Generator may determine that the user is interested in a model or type of television that the Click Generator is unable to supply. The Click Generator may submit this Enhanced Click Traffic into the CMP system as a Click Seller, where another Click Buyer in the Long Beach, Calif. area can purchase the Enhanced Click Traffic and direct traffic to the Click Buyer's website to provide relevant information.

The Click Marketplace system enables Click Sellers to submit Enhanced Click Traffic into the CMP system using several methods, including a Web Form or CMP defined Widget. For example, an internet user may use a search engine query to find reviews of their favorite automobile. Upon receiving the Click Traffic onto their website, the Click Generator may prominently display a CMP Widget on the webpage alongside relevant content. If the user wishes to find addition information about automobiles, they may select the categories of interest in the CMP Widget and generate an Enhanced Click Traffic unit. Upon submitting this Enhanced Click Traffic unit into the CMP system, the user is redirected to the Click Buyer's destination as determined by the CMP system. Furthermore, the Widget may present categories that have the highest levels of demand in the CMP system based on existing Buyer Campaigns.

The Click Marketplace system enables Click Buyers two methods of updating the Buyer Campaigns in the CMP system. The self service model enables Click Buyers to log into the CMP system and manually create campaigns. The second method enables Click Buyers to upload a Coverage Map as defined by the CMP system. The Coverage Map unit includes keyword mapping to specific categories in the CMP system, as well as bid prices and Destination URLs. The Coverage Map may be submitted at any time as required by the Click Buyer and will be effective immediately to the auction process.

Today the Click Buyer mentioned in the above examples is unable to purchase Enhanced Click Traffic that is relevant in intent and location. Existing systems do not allow Click Buyers to select the exact level of intent and location. For example, a Click Buyer is forced to buy all traffic that a search engine, advertising network, or other aggregator sends to the Click Buyer's website. Furthermore, the traffic that these aggregators send does not include Enhanced Click Traffic information that would enable the Click Buyer to better understand intent of users. Existing aggregators forces the Click Buyer to purchase each traffic unit at a predefined bid amount, and does not enable the market of Click Buyers to dynamically set the price of each traffic unit.

The CMP system 20 may further comprise an CMP click unit 30, such as one or more server computers that execute computer code in one implementation, that accepts and stores new Click Traffic, an CMP auction manager 36, such as one or more server computers that execute computer code in one implementation, that perform the auctioning process of the CMP system as described below in more detail. The CMP system may communicate with a seller click unit 32, such as one or more server computers that execute computer code in one implementation, that interfaces with and stores third party Click Traffic to be sold, a third party validation unit 34, such as one or more server computers that execute computer code in one implementation, that validates third party Click Traffic., and a third party buyer ping unit 38, such as one or more server computers that execute computer code in one implementation, that implements a ping campaign as is described below in more detail. The CMP system 20 may further comprise a Click Traffic rating unit 40, such as one or more server computers that execute computer code in one implementation, that provide a rating process of the CMP system as described in more detail below.

The CMP system 20 may further include one or more storage units, such as database tables in one implementation of the system that store data and are accessed by the various units of the system as described above. The system 20 may thus comprise a seller click database 50 that stores third party seller Click Traffic and interacts with the click unit 30, a seller campaign table 52 that stores a plurality of Click Seller campaigns for a plurality of Click Sellers in the CMP system as described below and a seller account table 54 that stores account information about each seller in the CMP system. In one embodiment, the seller account table may include an Object ID field, Identification Fields, a Login field, a Password field, and Payment Information fields and the seller campaign table may include an Object ID field, a Seller ID field, a User Defined Name field, a Collection Method field and a Quality Rating field. The Click Seller campaigns enable the Click Sellers to track the performance of different variations of Click Traffic generated using different methods.

The CMP system may further comprise a buyer campaign table 56 that stores a plurality of Click Buyer campaigns for a plurality of Click Buyers in the CMP system as described below and a click type table 58 that stores the different types of Click Traffic (such as mortgages, plumbers, autos, etc.) and the characteristics, or filters, for the different types of Click Traffic (such as mortgage amount, property type and house location for the mortgage Click Traffic or house location and type of plumbing work for a plumbers Click Traffic, or automobile make and model for automobile Click Traffic). In one embodiment, the click type table may include an Object ID field, a Name field, a Sharing Allowed field, and XML Schema (Field 1, Field 2, Field3 . . . ) fields, and the buyer campaign table may include an Object ID field, a Buyer ID field, a User Defined Name field, a Click Type field, Location Fields, a Max Age field, a Min Quality field, Type-Specific Filter Fields, Bid Amount field and Sharing Level field(s), an Activity Status field, a Bid Type field, and Destination URL field.

The CMP system 20 may further include a Click table 60 that interfaces with the CMP click unit 30 and the CMP auction manager 36 and stores information about each Click in the CMP system and a validating ratings table 62 that interfaces with the CMP click unit 30 and stores information about the validating ratings of the Click Traffic. In one embodiment, the Click table may include an Object ID field, a Ping ID field, a Seller Campaign ID field, an Auction Thread ID field, a Click Type field, Consumer Contact Information fields, a Generated Timestamp field, an Actual Payout field and a Sold Timestamp field. The CMP system 20 may further comprise one or more click auction threads 64 wherein a click auction thread is created for each click as described below in more detail. The CMP system 20 may further comprise a buyer account table 66 that interfaces with the CMP auction manager 36 and stores information about each of the Click Buyers in the CMP system and a Click User sold table 68 that interfaces with the CMP auction manager 36 and stores information about the Click Traffic that are sold in the CMP system to each individual Click Buyer. In one embodiment, the buyer account table may include an Object ID field, Identification Fields, a Login field, a Password field and Billing Information fields, and the Click User sold table may include an Object ID field, a Click ID field, a Buyer Campaign ID field, a Click Type field, Consumer Contact Information fields, a Generated Timestamp field, a Price Paid field and a Bought Timestamp field.

In addition to the tables shown in FIG. 1, the CMP system 20 further may include a number of other tables including a click ping table, a click post table, a buyer campaign ping table, a budget table and a bid table. The click ping table stores information about a ping (a conditional bid for a particular type of click that fits certain parameters) and may include an Object ID field, a Seller Campaign ID field, a Click Type field, a Last Name field, a Phone Suffix field, a Zip Code field, Type-Specific Field Values fields, a Generated Timestamp field and a Minimum Payout field. The click post table that stores information about a click that has been posted for sale by a Click Seller and may include an Object ID field, a Ping ID field, a Seller Campaign ID field, a Click Type field, Consumer Contact Information fields, XML Type-Specific Field Values, a Generated Timestamp field and a Posted Timestamp field. The buyer campaign ping table stores information about one or more ping campaigns (described below) for one or more Click Buyers and may include an Object ID field, a Buyer Campaign ID field, a Click Type field, a Last Name field, a Phone Suffix field, a Zip Code field, Type-Specific Field Values fields and a Generated Timestamp field. The budget table stores information about a budget for either a buyer campaign or a click buyer account and may include an Object ID field, a Level field, a Level ID field, a Dollar Amount field, a Number of Click Traffic field and a Timeframe field, and one or more Destination URL fields. The budget may specify the maximum number of Click Traffic and/or the maximum amount of money to spend on Click Traffic during one or more time periods and the budget may be associated with a particular buying campaign or with a particular Click Buyer account. Because the balances of these budgets will change over time as the Budget timeframes expire or Click Buyers modify the budget settings, the active auction approach enables these changes to be reflected in the auction outcome, potentially increasing the price paid for a Click. The Destination URL field identifies the website or other internet destination where the Enhanced Click Traffic will be directed to after a successful auction completion.

The bid table may store the bids from the plurality of Click Buyers associated with the CMP system and may include an Object ID field, an Auction Thread ID field, a Campaign ID field, an Amount field, a Max Sharing field and Filters Matched fields.

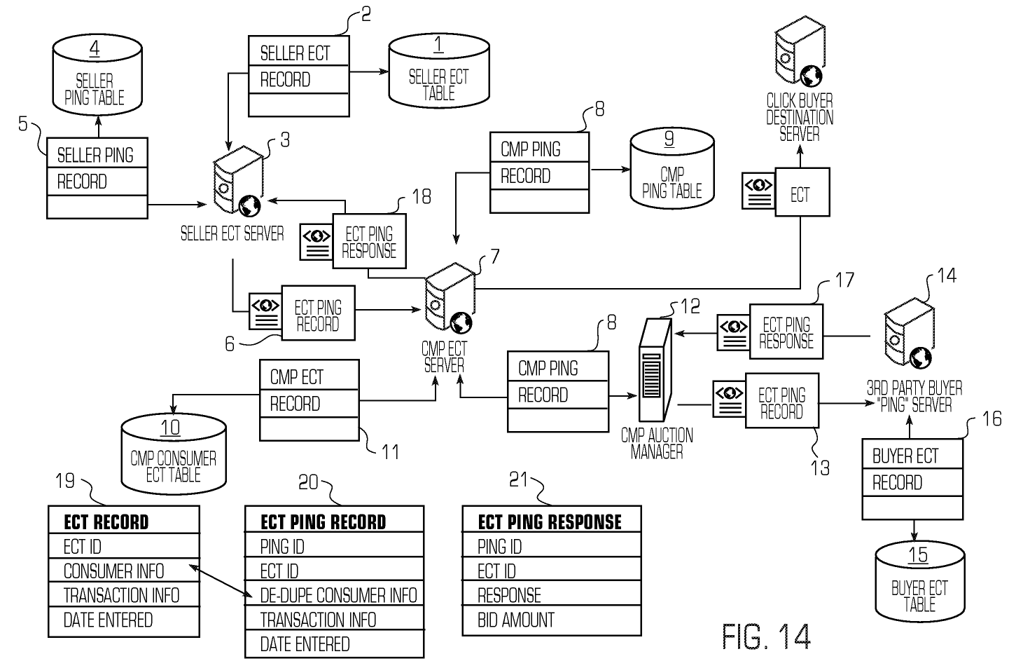

The CMP system shown in FIG. 14 depicts Internet companies that collect, or “Generate” a wide variety of Click Traffic to sell them to one or more Click Buyers in an auction format. This auction format ensures that a volume of Click Traffic from multiple Click Sellers is priced and sold efficiently to maximize yield to the Click Seller while giving control of the Click purchase to the Click Buyer. The system uses a unique method to match Click Traffic with Click Buyers, enabling the Click Buyer to specify the location, type, characteristics, and quality of Click Traffic they would like to purchase either through a standing order called a “Buying Campaign”. Like many auction-based system the CMP determines to which Buyer to sell the Click based on which Buyer or combination of Buyers that offers the highest price.

Each buying campaign is set up by a Click Buyer (where each Click Buyer can have one or more buying campaigns) and allows the Click Buyer of that buying campaign to specify certain parameters that are used to identify Click Traffic that are of interest to the particular Click Buyer as well as selecting the method for entering the Click Buyer's bid into each click auction. For example, the buying campaign enables the Click Buyer to: 1) specify the price and budgets for buying Click Traffic in a “Fixed Buying Campaign”.

The CMP system 20 enables the simultaneous pricing of a click to different numbers buyers who will “share” the click, and then the CMP system sells the click to the group of buyers who generate the highest revenue for a click. The CMP associates bid with each campaign, and each bid specifies a dollar amount and maximum number of other buyers to share the click with (the “Sharing Field”). There can be a plurality of bids associated with one buyer campaign, each with a different sharing level. To allow the sharing, Click Buyers do not need to do anything other than specify how much they are willing to pay for a maximum level of sharing, and the system groups these bids together. The sharing fields above allow the CMP system to support multiple levels of sharing and multiple bids from a single Click Buyer. For example, one embodiment of the invention might have a user interface that enables a Click Buyer to create a buyer campaign that specifies a bid of $2.00 if there is no sharing, $1.50 if the click can be shared with one other buyer, $1.50 if the click can be shared with two other buyers, etc so that the CMP system can be set up to allow a Click Buyer to enter different bid amounts for clicks to be shared amongst a maximum of 1, 3, 5, 6, or 10 Click Buyers. The CMP system user interface dictates what values can be entered for sharing by an individual Click Buyer, but the backend system will clear clicks to the group of Click Buyers that generate the highest return based on any sharing value bid that is in the system. Depending on how the Click Type is set up in the system (e.g., the amount of sharing that is allowed for the particular click type, such as sharing with a maximum of two buyers for automobile clicks or sharing with a maximum of 4 buyers with mortgages), the user interface controls what can be entered by the Click Buyer. At any time, the CMP system provides complete flexibility in the number of buyers that can be grouped together and compared to determine the highest value group of buyers. In other words, the CMP system will process whatever sharing level has been saved in the system (theoretically every single sharing increment up to thousands is supported), supporting any user interface design for controlling the Click Buyer input of bids for sharing levels. In order to facilitate sharing, the CMP system may direct the Enhanced Click Traffic to one or more destinations using one or more browser components such that each Click Buyer will receive a single Enhanced Click Traffic unit.

Since many Click Sellers have systems used to manage the Click Traffic that they generate, the CMP system supports multiple methods for entering Click Traffic into the system for Sale. As shown in FIG. 14, Click Sellers can set up their HTML Web forms or a CMP widget to be submitted to the CMP directly by the customer. In addition, Click Sellers that collect Click Traffic and save them on their own systems that can send the Click Traffic to the CMP system in a server-to-server exchange called a Server Post. The CMP system also makes it easier for Click Sellers to Post Click Traffic to the system by allowing them to map the fields in their tables to the fields in the CMP system for each Click Type. By so doing, the CMP system eliminates the need for the Click Seller to make significant modifications to their data structures in order to sell their Click Traffic.

Since Click Sellers may have established relationships with multiple partners that buy Clicks, the CMP allows Click Sellers to make a server-to-server request for a payout quote prior to selling the Click through the CMP. This type of price quote request is called a “Ping”, and it contains enough information about the Click to enable the CMP to run an Active Auction on the Click, without including enough information to enable the CMP to actually sell the Click. If the Click Seller system determined that the payout amount is acceptable, the system can then complete a Server Post of the Click Traffic.

Different Click Sellers use different techniques in generating Click Traffic. As a result, the ease with which the resulting Click can be turned into a customer varies from one Click Seller to another. The measure of the ease with which a Click can be converted to a customer is referred to as the “Quality” of the Click. Differences in Quality affect the value of the Click to the Click Buyer. The CMP uses a unique combination of measures to establish a Quality Rating for each Click entered into the system. The CMP combines three factors to calculate a real-time Quality Rating for each Selling Campaign in the CMP: 1) ratings provided by the Click Buyers, 2) A rating from a third-party validation service, and 3) The results of a survey of the customer. Any Click that enters the system is associated with one Selling Campaign and inherits the Quality Rating of that Selling Campaign. Rather than tie these Quality Ratings to the Click Seller account directly, the CMP uses the Selling Campaign system object to enable one Click Seller to deliver Click Traffic of varying quality.

Once a Click User is sold, the CMP creates “Click User” records in the click user table for each of the Click Buyers. These Click User records are associated with the Click, which is associated with the Selling Campaign, which is associated with the Seller Account. The Click Buyer accesses his or her own Click User in the CMP, and the Buyer Rating, entered by the Click Buyer through the CMP Buyer user interface, is stored in the Click User record. Now, the Click Buyer campaign creation and Click Seller campaign creation are described in more detail.

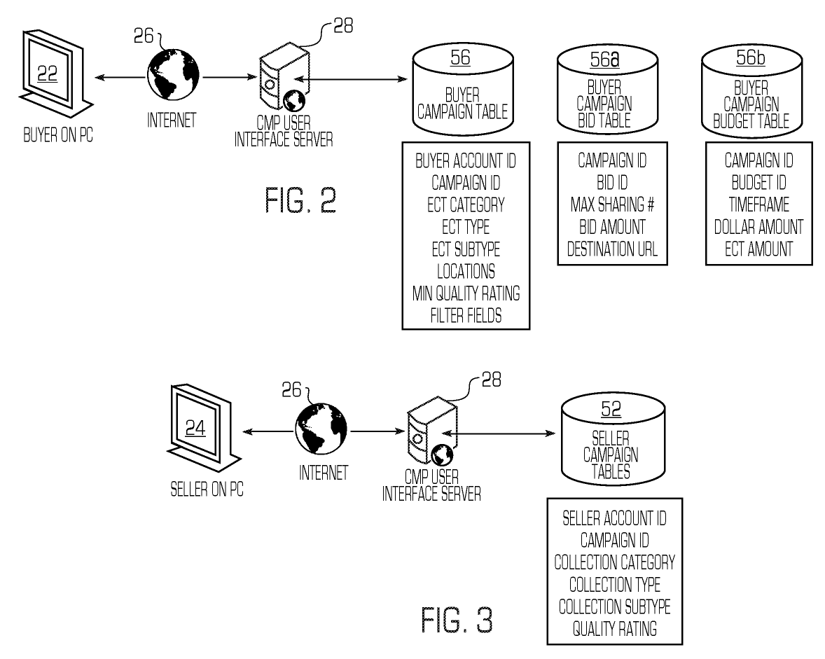

FIG. 2 illustrates an example of a Click Buyer campaign creation workflow implemented in the click marketplace system shown in FIG. 1, and FIG. 3 illustrates an example of a Click Seller campaign creation workflow implemented in the click marketplace system shown in FIG. 1. As shown in these figures, a Click Buyer or Click Seller can, using the link 26, access the CMP user interface unit 28 and create a new click buying campaign that is stored in the buyer campaign table 56, the buyer campaign bid table 56a and the buyer campaign budget table 56b, or create a new click selling campaign that is stored in the seller campaign table 52, respectively. In one embodiment, the Click Buyer or Click Seller can access the CMP system using a typical Web browser application by entering the appropriate user identified and password. The CMP system presents the Click Buyer with a series of pages that enable the Click Buyer to specify (as shown in FIG. 2) the type of Click to purchase, the location of the Click, the characteristics of the Click, the bidding method, the bids (including the max sharing number and/or bid amount) and the Budgets in dollar amount and number of Click Traffic for different timeframes. The CMP system presents the Click Seller with a series of pages that enable them to specify the method they are using to capture Click Traffic and associate the data with a seller account ID, a campaign ID as shown in FIG. 3.

Based on the Click Type selected when creating a Buying Campaign, the Click Buyer will be presented with the relevant click characteristics that are associated with that type of Click Traffic. For example, if the Click Buyer is purchasing Plumbing Service Click Traffic, he or she might be asked to specify the zipcode, or a type of job requested and/or whether it is for emergency service. If the Click Buyer is purchasing Mortgage Service Click Traffic, he or she might be asked to specify the loan amount and type of home among other mortgage-related criteria. The CMP has a Click Type Table that stores the appropriate data schema and selection values for each type of Click.

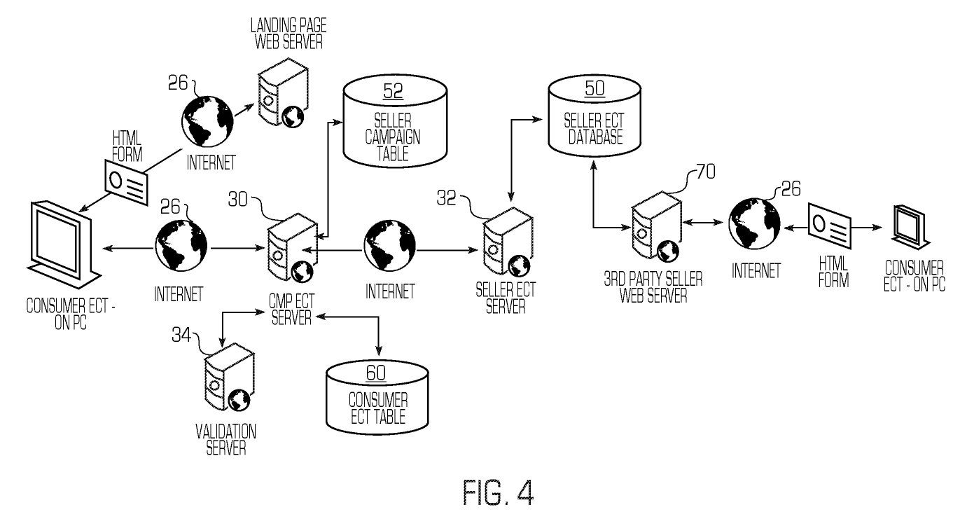

FIG. 4 illustrates an example of a click upload workflow implemented in the click marketplace system shown in FIG. 1. There are two main methods used by Click Generators to enter, or “Post”, Click Traffic into the CMP system including: 1) direct posting the Click User to CMP system and 2) initiating a Ping/Post request prior to delivering Click Traffic to CMP. In the direct posting method, a customer on a computing device can access the an HTML Web page that collects the appropriate click information and performs an HTTP Post directly to the CMP (the CMP click unit 30). The click Generators can create the form themselves or make a request to the CMP system to serve a click collection form to the customer for them. Alternatively, the Click Generator can collect the Click information themselves (using their own third party seller Web server 70 which is accessed by the customer over the link), and then the Click Generator can store the information in their own database system. Once they have stored the Click, the Click Generator can use one of several methods to Post the Click to the CMP system through a server-to-server connection, for example, through an HTTP POST or a Web Service. Prior to Posting the Click to the CMP system, the Click Generator has the option to send a pricing request for the click called a “Ping” wherein the click generator sends a limited amount of information about the Click to the CMP to determine the payout they will receive for the Click. Then, based on the response from the CMP, the Click Generator can decide whether or not to Post the Click to the CMP for sale.

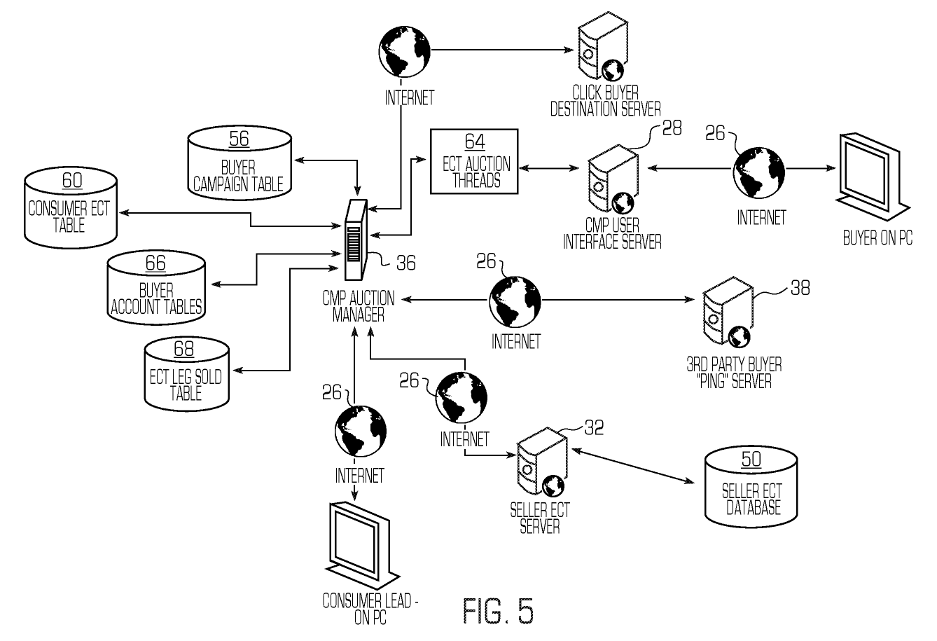

FIG. 5 illustrates an example of a click auction workflow implemented in the click marketplace system shown in FIG. 14. When an auction is complete, the CMP Auction Manager determines the Click Buyer that has won the auction. The Auction Manager then redirects the Enhanced Click Traffic using HTTP Status code 302 or other method defined in the HTTP standard by World Wide Web Consortium. Once the user has been redirected using one of the methods described above, the full auction process is considered completed.

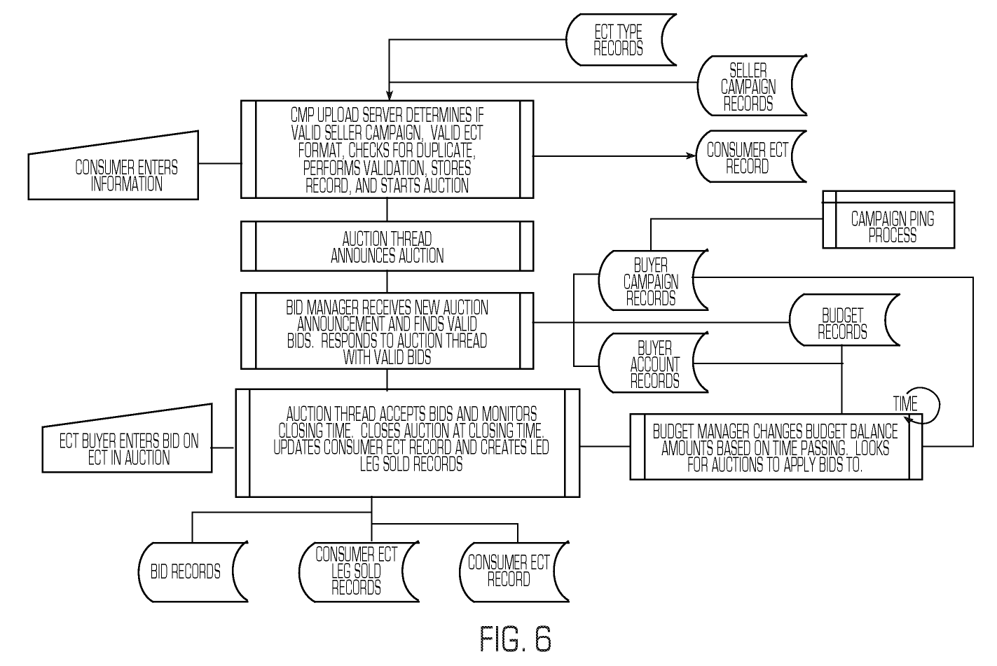

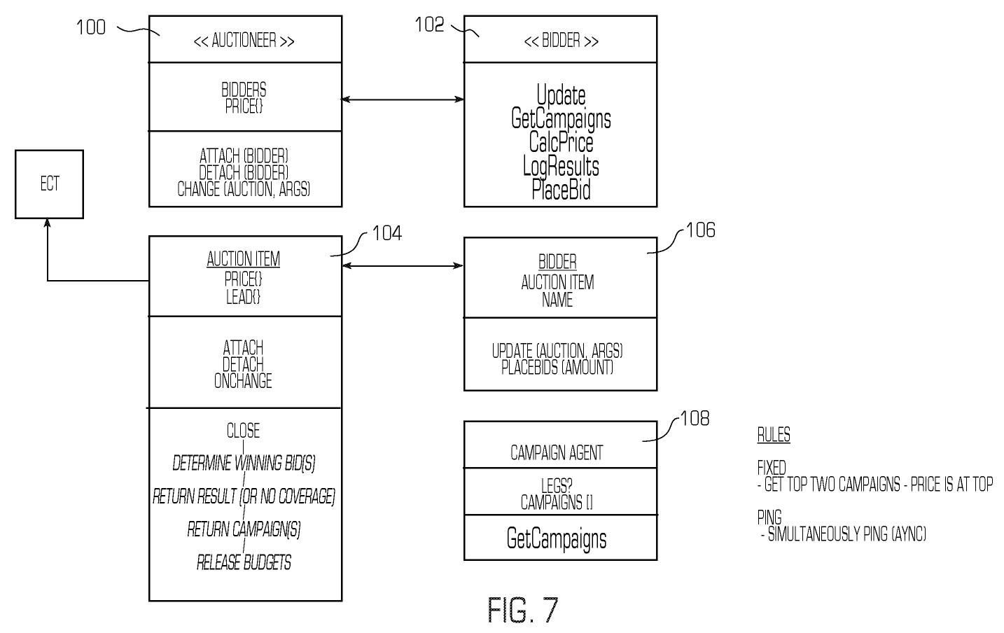

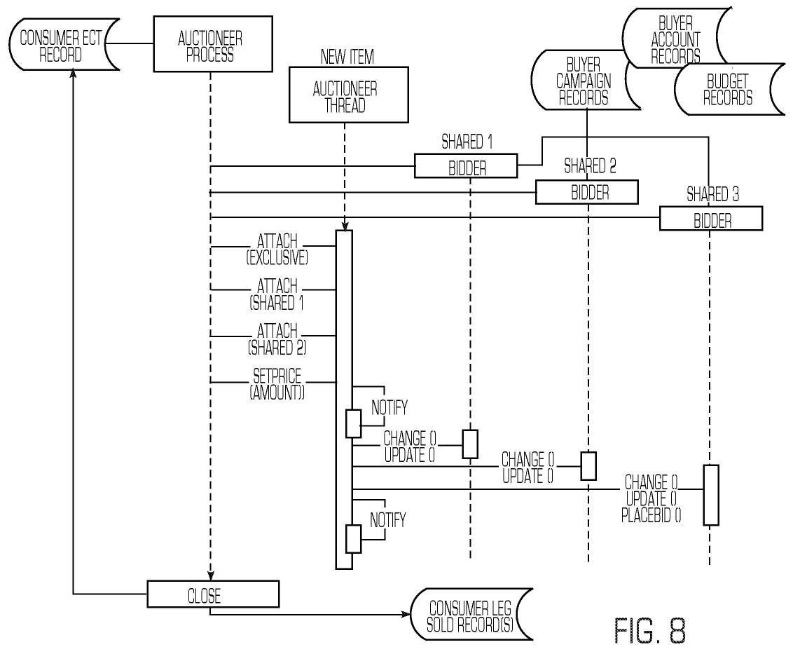

FIG. 6 illustrates an example of an auction workflow implemented in the click marketplace system shown in FIG. 1, FIG. 7 illustrates an example of auction logic in the click marketplace system shown in FIG. 1 and FIG. 8 illustrates an example of an auctioneer system function flow implemented in the click marketplace system shown in FIG. 1.

The CMP system has an “Auctioneer” process that creates an auction process (“Auction Thread”) for each individual Click Ping (a proposal to post a click if there is sufficient demand) or Post (a click for sale) received from a valid Seller Campaign. This Auction Thread 64 receives bids from the “Bid Manager”, “Budget Manager”, or “Campaign Manager” processes and identifies the set of Click Buyers who will purchase the Click, calculates the amount of money to be paid to the Click Seller, and creates Click User Sold records for each Click Buyer. The Auction Thread is an individual process within the CMP Auction Manager subsystem that runs for a defined amount of time, which may be different for each Click, accepting all bids for the Click during the timeframe.

Rather than simply doing a database query of the Buyer Campaigns to determine the highest bidder or group of bidders and awarding the Click based on the database query results, the CMP Auction first queries the Buyer Campaigns that match the characteristics of the Click to get their bids for each level of sharing. There is a separate “Sharing Bid Thread” created for each level of sharing that has a bid in the system. Each of these individual Sharing Bid Threads manages the initial and subsequent bidding activity for the level of sharing for the Auction Thread.

The Auction Thread allows Click Buyers or Buyer Campaigns to place bids into the Auction Thread, where they are processed by the appropriate Auction Thread. As changes to the Auction Thread occur, the Auction Thread sends out notifications to all Campaigns that are participating in the auction, letting them know the current status of the auction and allowing them to submit new bids.

The benefit of this approach is that in addition to including bids from Campaigns that qualify at the moment the Click enters the CMP, the Auction Thread can accept qualifying bids that come into the system after the Click has entered the CMP. For example, if a Buyer Campaign had a budget limit that had been exceeded when a Click initially entered the CMP, but the Buyer increased the budget before the Auction Process ended, the Budget Manager within the CMP would be able to submit the bid to the Auction Thread. As another example, if a Click Buyer added a new Buying Campaign or modifies an existing Buying Campaign so that it matches the characteristics of Click Traffic with active Auction Threads, the Campaign Manager would apply the bids from these Campaigns to those active Auction Threads rather than waiting until a new Click entered the system to apply the Campaign bid to a Click.

In addition, this method of running the auction allows for “Ping Buying Campaigns”, where the Click Buyer's bid is set through a server-to-server process. This method also allows for live bidding by Buyers for individual Click Traffic with active Auction Threads. This active method of managing the auction of a Click gives the system the flexibility to take advantage of the entire window of time over which a Click can be sold to increase the number of bids that can be applied.

The system can be set up to use a different model from the Threaded “Listener” model described herein. The CMP system encompasses any system that creates a process that runs for a duration of time and can use a combination of 1.) Queries from static “Purchase Order” or “Bidding” objects that specify click characteristics, prices offered and budgets; 2.) Changes to the Purchase Order or Bidding objects that change their participation status in currently active auctions; 3.) Changes to the budget position of the buyer's account; 4.) server-to-server requests for a bid on a specific Click; or 5.) Live bids entered into the system by Buyers as shown in FIG. 6.

FIG. 7 illustrates the auction logic when implemented in software using one or more objects and database tables. The auction logic may include an auctioneer object 100 for each auction thread and a bidder object 102 wherein the auctioneer object tracks the bidder threads for the particular auction thread and the bids offered by those bidders and can perform the functions of attaching (adding) a new bidder thread, detaching (removing) a bidder or changing the auction parameters or arguments. Each bidder thread object is associated with each bid level in existence in an auction and can perform the functions of update (when information about a bid at that level is updated), GetCampaigns to find qualifying seller campaigns that might have valid bids that might apply to the bidder thread, CalcPrice to calculate the aggregate price to be offered by the bidder thread for a particular auction, LogResults to store the results for the current auction for the bidder thread and PlaceBid to place a bid into the auction thread. The auction logic may also include an auction thread 104, a bidder thread 106 and a campaign agent 108. The auction thread item may be an object associated with a particular click that performs the functions of attach, detach or on change and, when the auction is completed/closed, the auction thread item determines the winning bid(s), returns the results (or no coverage), returns the Buyer campaign identifier(s) and release budgets that were not associated with the winning bids. The bidder thread item 106 is associated with a particular auction thread item and can perform updates and place bids for a particular amount. The system function flow of a typical auction is shown in FIG. 8.

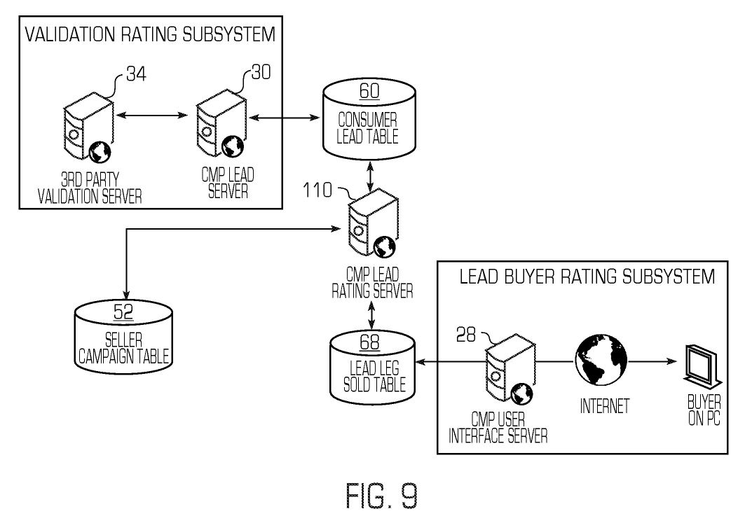

FIG. 9 illustrates an example of a click rating workflow implemented in the click marketplace system shown in FIG. 1. The CMP system runs a Click Rating subsystem to track the quality of Click Traffic that are Posted under each Selling Campaign. There is a current rating, associated with each Selling Campaign (“Campaign Rating”), that is inherited by each Click that is Pinged or Posted as part of the Selling Campaign. The Campaign Rating value is calculated as shown in FIG. 9 using three data points; 1.) the rating by the Click Buyer(s), 2.) the results of a validation check against a database of customer information, and 3.) a survey of the end customer. The CMP Click Rating subsystem performs an algorithm to calculate the Campaign Rating, which is the weighted average rating of Click Traffic that have been sold associated with each Selling Campaign. The Campaign Rating is sent through the Auctioneer Thread to the Auction Thread when a Click is auctioned, enabling the CMP to allow Buyers to specify the minimum quality rating of Click Traffic they would like to buy.

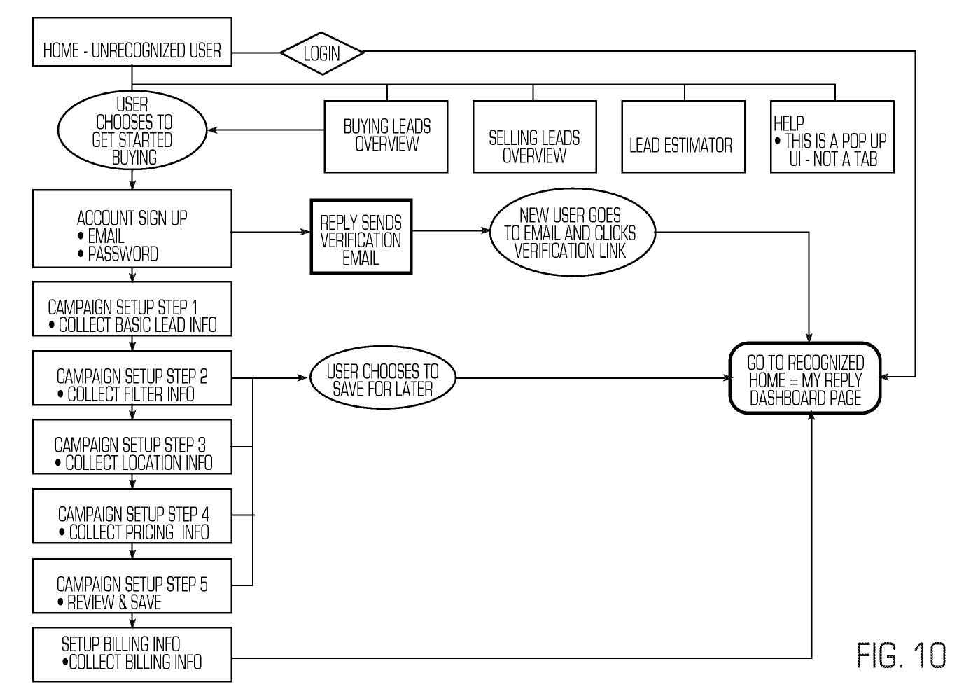

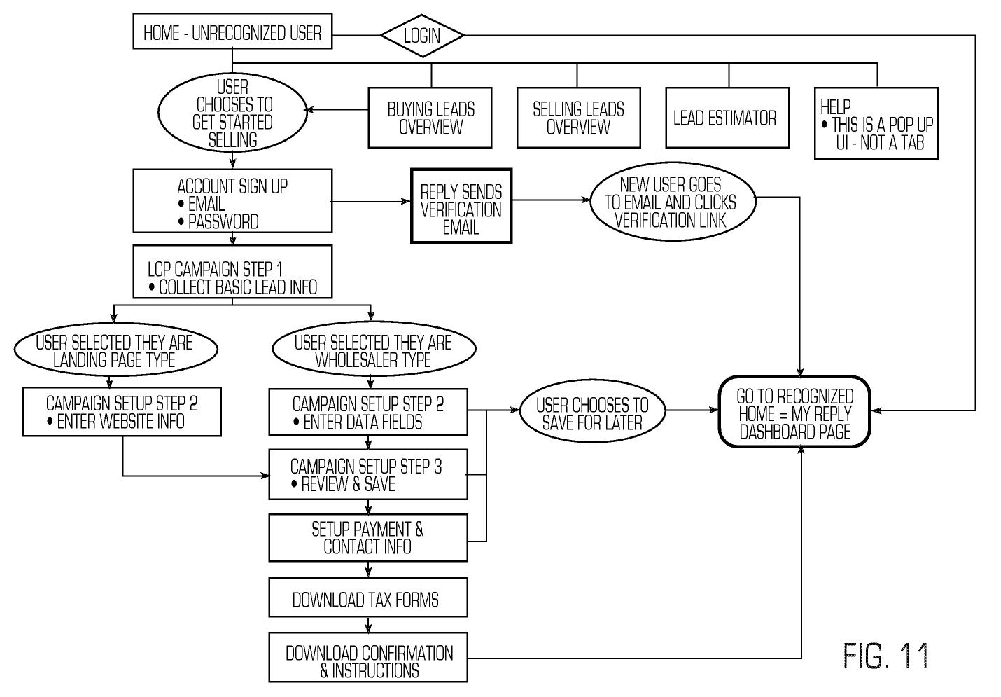

FIG. 10 illustrates an example of a buyer information workflow implemented in the click marketplace system shown in FIG. 1 and FIG. 11 illustrates an example of a seller information workflow implemented in the click marketplace system shown in FIG. 1. These diagrams show the workflow for a buyer to enter information into the CMP system and the workflow for the seller to enter information into the CMP system, respectively.

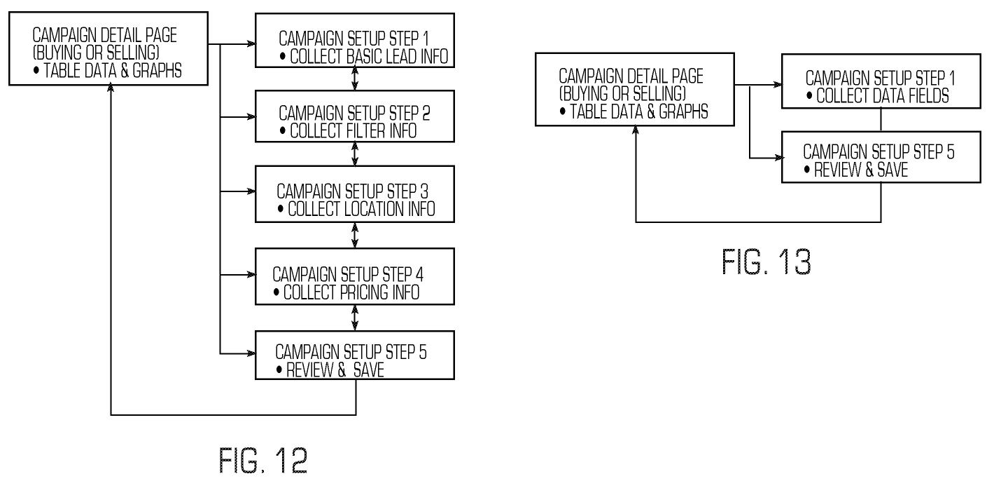

FIG. 12 illustrates an example of a buying campaign management workflow implemented in the click marketplace system shown in FIG. 1 and FIG. 13 illustrates an example of a selling campaign management workflow implemented in the click marketplace system shown in FIG. 1.

Thus, a click marketplace system and method are provided that include a storage system that stores a plurality of Click Traffic wherein each Click is electronic contact and transactional information that provides someone with an opportunity to sell a good or service to a prospective customer or provide relevant information and a Click Seller unit that stores one or more selling campaigns for one or more Click Sellers, each selling campaign enabling the association of one or more Click Traffic to be sold in the click marketplace system and a Click Buyer unit that stores one or more buying campaigns for one or more Click Buyers, each buying campaign including one or more parameters specifying the characteristics of Click Traffic to be bought by the Click Buyer associated with the buying campaign. Each buying campaign has one or more bids associated with the buying campaign wherein each bid specifies the amount offered by the Click Buyer for a specific level of sharing. The buying campaign also has one or more budgets associated with each buying campaign wherein each budget specifies a maximum dollar amount to spend and/or the maximum number of Click Traffic to purchase in a specified timeframe. The click marketplace system and method also has an auction manager that performs a time period limited auction for each Click entered into the system for sale by a Click Seller to one or more Click Buyers and the auction manager has a click auction thread for each Click that sets a time period for an auction of each Click associated with the selling campaign, that accepts bids from the one or more Click Buyers through several means, and that sells Click Traffic associated with the selling campaign to the group of Click Buyers that generates the greatest amount of money. The click marketplace system and method also has a budget manager that ensures that individual Click Buyers or individual buying campaigns do not have their bids applied to click auctions if so doing would risk exceeding one or more budget rules entered by the Click Buyer, a campaigns manager that submits bids associated with each buying campaign to each relevant click being sold, and a bids manager that submits bids stored in buying campaigns, submitted in association with a buying campaign by a third-party system, or entered directly through a computing device by a Click buyer.

The click auction thread of the click marketplace system and method may also receive bids from one or more buying campaigns and receive live bids from one or more Click Buyers. The one or more bids associated with each buying campaign may have a sharing parameter that specifies a level of sharing the Click Traffic being sought in the buying campaign, with or without a system limit on the numerical sharing level that can be assigned to the bid. The one or more bids of each buying campaign may also specify a bid price representing the amount of money the Click Buyer is willing to spend. Alternatively, the bid price can be requested at the time of the auction of an individual click through a process termed a “Ping” in which a server-to-server request is sent to a computer device under the Click Buyer's control, such request including information about the location and type of the click, and a response is sent back to the system with a dollar amount the Click Buyer is willing to bid. The response in the “Ping” may also include the sharing level of the bid returned. The response in the “Ping” also may include multiple bids, each bid with a different sharing level specified. In the click marketplace system and method, a process in the system receives the “Ping” response and places the bid into the appropriate sharing level thread.

The one or more budgets in the click marketplace system and method may be associated with each buying campaign or each Click Buyer account and the budgets include a maximum monetary amount and/or a maximum number of Click Traffic, for the Click Traffic to be bought within a specified timeframe. The selling campaign unit may include a mapping unit that associates fields in a third party Click into fields in the storage system of the click marketplace system and method.

In the click marketplace system and method, the Click Auction unit creates an individual auction process for each click that is submitted to the system with a defined start and stop time during which bids from one or more buyers are evaluated to determine how to sell the click. Each individual auction process creates one or more sharing bid threads to accept bids for different levels of sharing, such sharing bid threads to be used to create and update an aggregate bid amount for the particular level of sharing to be compared against the aggregate bid amounts of the other sharing levels in determining how to sell the click. The multiple auction processes can enter bids on behalf of a Click Buyer into one or more active sharing bid threads and the bids are included in a determination of how to sell the click. The multiple auction processes are able to enter bids on behalf of a campaign manager that accepts changes to buying campaigns, a budget manager that monitors changes to budgets based on time passing or other buying campaign activity, or a bid manager that accepts live bids from Click Buyers through a user interface device.

In the click marketplace system and method, the selling campaigns are assigned a current rating value by the system, such rating value being calculated through a combination of data collected from a results of a combination of the source of the click, the rating values assigned to the click by the Click Buyers. The current rating value associated with a selling campaign is inherited by each click as it is entered into the system for auction and sale, such rating then being used for the purpose of determining which buying campaigns qualify for bidding on the click.

FIG. 14 illustrates a ping campaign duplication detection process workflow of the implemented in the click marketplace system shown in FIG. 1. The ping campaign duplicate detection process may be carried out, in one embodiment, by the CMP click unit 30 shown in FIG. 1 (for the incoming Click Traffic) and by the third party Buyer Ping Unit 38 (for the Click Traffic being offered to buyers). Those portions of the CMP click unit 30 and the third party Buyer Ping Unit 38 may be collectively a click duplication detection unit. In the workflow, a third-party click seller stores Click Traffic in a table 1 in a click record 2 with a format 19 that contains a click identifier, consumer information, transaction information, and the date the click was entered by the consumer. The Seller Click Unit 32 creates and stores in the Seller Ping Table 4 a Ping Record 5 with a format 21 that contains a ping identifier, click identifier, de-dupe consumer information, transaction information, and the date entered. The de-dupe consumer information may be one or more pieces of information that allow the system to uniquely identify each ping campaign. For example, the de-dupe consumer information may be two or more pieces of information about the consumer (zip code and last four digits of social security number, etc.), a hash of the relevant consumer information, a globally unique identifier, etc.

The Seller Click Unit 32 also creates and transmits over a network a Click Ping Record 6 containing the Click Ping information 21 to the CMP Click Unit 30, which creates its own version of the Click Ping Record 8. For each click ping, the CMP Click Unit 30 searches the CMP Click Table 60 using the Transaction Info, De-Dupe Consumer Info, and Date Entered to see if there is a CMP Click Record with matching information. If there is an CMP click record 8 already in the CMP system with matching information, the Click Ping is identified as being a duplicate to one already entered in the system and the system handles it according to the business rules for duplicate click submissions. For example, there might be a rule that the duplicate clicks will not be accepted into the system and that an error message will be returned to the click Seller, or there might be a rule that duplicate clicks will be accepted into the system, but not sold to the same Buyer as the initial Click. If there is not an CMP click record 8 already in the CMP system with matching information, then the CMP Click Unit 30 can send the Click Ping Record 8 to the CMP Auction Manager 36 for processing, at which time the CMP Auction Manager 36 can create and send a Click Ping Record 13 across a network to the 3^{rd} Party Buyer Ping Unit 38. The 3^{rd} Party Buyer Ping Unit 38 searches a Buyer Click Table 15 using the Transaction Info, De-Dupe Consumer Info, and Date Entered to see if there is a Buyer Click Record already in the system with matching information. If there is a Buyer click record already in the system with matching information, the Click Ping is identified as being a duplicate to one already entered into the system and the system handles it according to the business rules for duplicate click submissions. For example, there might be a rule that the duplicate clicks will not be accepted into the system and that an error message will be returned to the click Seller, or there might be a rule that duplicate clicks will be accepted into the system, but not sold to the same Buyer as the initial Click. If there is not a Buyer click record already in the system with matching information, then the 3^{rd} Party Buyer Ping Unit 38 responds to the CMP Auction Manager 36 with a Click Ping Response 17 in a Click Ping Response Format 23 containing the Ping ID, Response, and Bid Amount which indicates interest in buying the Click. Based on the results of the auction, the CMP Click Unit 30 returns a Click Ping Response 18 to the Seller Click Unit 32. In this manner, the CMP system described above checks for duplicate clicks when entering into the CMP system (a new click being entered into the system) as well as enabling Buyers to check for duplicate clicks within their systems prior to bidding for a click. The proper handling of duplicate clicks (either incoming or outgoing clicks) is important to prevent the unintentional sale the same click multiple times to the same buyer, and to maintain the appropriate level of sharing for the click.

In summary, the system is able to detect duplicate clicks and then allow the system to handle the duplicate click in one or more different manners (the business rules referred to above.) For example, the situation may be that the duplicate click occurs the first time that the click came in and the system already sold two legs so the system may be programmed to decide that even though it is a duplicate, the system will accept it and sell one leg to a different buyer.

While the foregoing has been with reference to a particular embodiment of the invention, it will be appreciated by those skilled in the art that changes in this embodiment may be made without departing from the principles and spirit of the invention, the scope of which is defined by the appended claims.

1. A click marketplace system, comprising:
a storage system that stores a plurality of Enhanced Click Traffic wherein each Enhanced Click consists of electronic transactional information that represents an Internet user;
an Enhanced Click Traffic unit which represents user intent through keywords or other data fields and provides an Enhanced Click Traffic Buyers an opportunity to sell a good or service, or provide relevant information to a prospective customer;
a Click Seller unit that stores one or more selling campaigns for one or more Click Sellers, each selling campaign enabling the association of one or more Click Traffic to be sold in the click marketplace system;
a Click Buyer unit that stores one or more buying campaigns for one or more Click Buyers, each buying campaign including one or more parameters specifying the characteristics of Click Traffic to be bought by the Click Buyer associated with the buying campaign; and
an auction manager that performs an auction for each click stored in the storage system for sale by a Click Seller to one or more Click Buyers.

2. The system of claim 1, wherein buyers are able to direct the Enhanced Click Traffic to a predefined destination address using universal resource locators or other predefined method.

4. The system of claim 1, wherein each buying campaign further comprises one or more bids wherein each bid has a sharing parameter that specifies a level of sharing of the Click Traffic being sought in the buying campaign.

5. The system of claim 1, wherein each buying campaign further comprises one or more budgets wherein each budget has a maximum monetary amount for the Click Traffic to be bought within a specified timeframe by the Click Buyer associated with the buying campaign.

6. The system of claim 1, wherein each buying campaign further comprises one or more budgets wherein each budget has a maximum number of Click Traffic to be bought within a specified timeframe by the Click Buyer associated with the buying campaign.

7. The system of claim 1, wherein each Click Buyer has one or more budgets associated with the Click Buyer wherein each budget has a total amount of money budgeted for Click Traffic within a specified timeframe by the Click Buyer.

8. The system of claim 1, wherein each Click Buyer has one or more budgets associated with the Click Buyer wherein each budget has a maximum number of Click Traffic to be bought by the Click Buyer within a specified timeframe.

9. The system of claim 1, wherein the Click Seller unit further comprises a mapping unit that maps fields in a third party click into fields in the storage system.

10. The system of claim 1, wherein the click seller unit further comprising a unit for generating a selling campaign.

11. The system of claim 10, wherein the click buyer unit further comprising a unit for generating a buying campaign.

12. The system of claim 1, wherein the storage system further comprises a database server.

13. The system of claim 11, wherein the Click Seller unit, Click Buyer unit and auction manager each further comprise one or more server computers.

14. The system of claim 1 further comprising a click quality detection unit that compares a new click to the clicks stored in the storage system to determine the quality of the click, including detecting duplicate clicks from the same user, fraud, and other relevant data.

15. The system of claim 1 further comprising a click duplicate detection unit that compares a click being sent to a Click Buyer with a set of clicks already purchased by the Click Buyer to determine if the sent click is a duplicate.

16. The system of claim 1 further comprising one or more of a widget and a landing page engine which displays available categories accessible to a publisher.

17. The system of claim 16, wherein the widget or landing page engine presents categories to the publisher based on demand in the click marketplace system.

18. The system of claim 15, wherein each click further comprises a de-dupe identifier that uniquely identifies each click and wherein the click duplicate detection unit compares the de-dupe identifier of the new click to the de-dupe identifier for each click in the storage system to detect duplicate clicks.

19. The system of claim 1, wherein the auction manager performs a time period limited auction for each click stored in the storage system for sale by a Click Seller to one or more Click Buyers.

20. The system of claim 19, wherein the auction manager further comprises a click auction thread for each click that sets a time period for an auction of each Click Traffic associated with the selling campaign, that accepts bids from the one or more Click Buyers and that sells the Click Traffic associated with the selling campaign to a group of Click Buyers that generate the greatest amount of money.

21. The system of claim 20, wherein the click auction thread receives bids from one or more buying campaigns.

22. A computer implemented click marketplace method that stores a plurality of Enhanced Click Traffic wherein each Enhanced Click consists of electronic transactional information that represents an Internet user, the method comprising:
storing, in a storage system, one or more selling campaigns for one or more Click Sellers, each selling campaign enabling the association of one or more Click Traffic to be sold in the click marketplace system;
storing one or more buying campaigns for one or more Click Buyers, each buying campaign including one or more parameters specifying the characteristics of Click Traffic to be bought by the Click Buyer associated with the buying campaign; and
performing an auction for each click for sale by a Click Seller to one or more Click Buyers.

23. The method of claim 22, wherein auction winners are selected based on a various factors including but not limited to a weighted distribution of clicks, total revenue obtained, date of auction, time of the day of auction, account history, Enhanced Click Traffic information and other relevant data.

24. The method of claim 22, wherein accepting the bids further comprises receiving bids from one or more buying campaigns.

25. The method of claim 22, wherein accepting the bids further comprises receiving live bids from one or more Click Buyers.

26. The method of claim 22, wherein each buying campaign further comprises one or more bids wherein each bid has a sharing parameter that specifies a level of sharing of the Click Traffic being sought in the buying campaign.

27. The method of claim 22, wherein each buying campaign further comprises one or more budgets wherein each budget has a maximum monetary amount for the Click Traffic to be bought within a specified timeframe by the Click Buyer associated with the buying campaign.

28. The method of claim 22, wherein each buying campaign further comprises one or more budgets wherein each budget has a maximum number of Click Traffic to be bought within a specified timeframe by the Click Buyer associated with the buying campaign.

29. The method of claim 22, wherein each Click Buyer has one or more budgets associated with the Click Buyer wherein each budget has a total amount of money budgeted for Click Traffic within a specified timeframe by the Click Buyer.

30. The method of claim 22, wherein each Click Buyer has one or more budgets associated with the Click Buyer wherein each budget has a maximum number of Click Traffic to be bought by the Click Buyer within a specified timeframe.

31. The method of claim 22 further comprising mapping fields in a third party click into fields in the storage system.

32. The method of claim 22 further comprising generating a selling campaign.

33. The method of claim 22 further comprising generating a buying campaign.

34. The method of claim 19 further comprising identifying duplicate Click Traffic by comparing a new click to the Click Traffic stored in the storage system to determine if the new click is a duplicate.

35. The method of claim 34, wherein each click further comprises a de-dupe identifier that uniquely identifies each click and wherein the click duplicate detection unit compares the de-dupe identifier of the new click to the de-dupe identifier for each click in the storage system to detect duplicate clicks.

36. The method of claim 22 further comprising a click duplicate detection unit that compares a click being sent to a Click Buyer with a set of clicks already purchased by the Click Buyer to determine if the sent click is a duplicate.

37. The method of claim 19, wherein performing the auction further comprises performing a time period limited auction further comprises accepting a bid with changed parameters for a particular click and adjusting the time period limited auction for a particular click being carried out by the click auction thread.

38. The method of claim 19, wherein performing the auction further comprises performing a time period limited auction for each click for sale by a Click Seller to one or more Click Buyers.

39. The method of claim 38, wherein performing a time period limited auction further comprises setting a time period for an auction of each Click Traffic associated with the selling campaign, accepting bids from the one or more Click Buyers and selling the Click Traffic associated with the selling campaign to a group of Click Buyers that win the auction.
